(19) United States
(12) Patent Application Publication
(10) Pub. No.: US 2016/0097699 A1
(43) Pub. Date: Apr. 7, 2016

(54) ESTIMATING REMAINING USAGE OF A COMPONENT OR DEVICE

(71) Applicant: General Electric Company, Schenectady, NY (US)

(72) Inventor: Bruno Paes Leao, Rio de Janeiro (BR)

(21) Appl. No.: 14/508,905

(22) Filed: Oct. 7, 2014

(51) Int. Cl. G01M 99/00

(52) U.S. Cl. CPC G01M 99/008

(57) ABSTRACT

Disclosed are a system, a computer-readable storage medium storing at least one program, and a computer-implemented method of remaining use estimation. An interface module receives measurement data indicative of a level of usage of an apparatus. A filter engine, based on first model data, generates a first value indicative of a probability that the RU of the apparatus reached a threshold RU value. The filter engine, based on second model data, generates a second value indicative of a probability of the received measurement data given that the RU of the apparatus reached the threshold RU value. The filter engine, based on the first and second values, generates output data that is indicative of a probability that the RU of the apparatus reached the threshold RU value.

### TECHNICAL FIELD

Example embodiments of the present application generally relate to processing data and, more particularly in example embodiments, to a system and method for monitoring components or equipment.

### BACKGROUND

A device or components of a device can wear down, degrade in quality, and even fail as the device is used. Component wear can reduce the effectiveness of the device. In some situations, the proper operation of the device may support a system or process. Thus, degraded performance or failure of the device can result in failure of the system or process. Wear of a component can also increase the risk safety hazards. In order to have the system or process running effectively and safely, maintenance and replacing parts can be scheduled.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various example embodiments discussed in the present document.

FIG. 1 is a network diagram depicting a client-server system, within which one example embodiment may be deployed.

FIG. 2 is a block diagram illustrating a monitoring architecture including multiple applications and components forming at least a portion of the client-server system of FIG. 1, according to an example embodiment.

FIG. 3 is a network diagram depicting an example embodiment of an asset monitoring system including multiple modules forming at least a portion of the client-server system of FIG. 1.

FIG. 4 is an interface diagram illustrating an example user interface of an asset monitoring application with multiple display elements delivered to a user device of an asset monitoring system, according to an example embodiment.

FIG. 5 is a flowchart illustrating an example method of generating an estimate of remaining usage of an asset, in accordance with an example embodiment.

FIG. 6 is a diagram graphically depicting an example method of processing prior probability model data, according to an example embodiment.

FIG. 7 is a diagram graphically depicting an example method of selecting likelihood model data, according to an example embodiment.

FIG. 8 is a flowchart illustrating an example method of generating estimates of remaining usage, in accordance with an example embodiment.

FIG. 9 is a flowchart illustrating an example method of monitoring a threshold state of remaining usage, in accordance with an example embodiment.

FIGS. 10A and 10B are plots graphically depicting an example method of generating prior probability model data, according to an example embodiment.

FIGS. 11A-C are plots graphically depicting a method, according to an example embodiment, of generating prior probability model data.

FIG. 12 is a plot graphically depicting an example method of generating likelihood model data, according to an example embodiment.

FIG. 13 is a flowchart illustrating an example method of generating estimates of a monitored apparatus in a threshold state, in accordance with an example embodiment.

FIG. 14 is a block diagram of a machine in an example form of a computer system within which instructions may be executed for causing the machine to perform any one or more of the methodologies discussed herein.

### DETAILED DESCRIPTION

### Overview

The systems, methods, and devices described herein each have several aspects, no single one of which is solely responsible for its desirable attributes. Without limiting the scope of this disclosure, some features will now be discussed briefly merely by way of example.

In one example embodiment, a system is disclosed. The system comprises an interface module configured to receive measurement data of an apparatus. At least a portion of the measurement data is indicative of a level of usage of the apparatus. The system further comprises a data access module configured to access first and second model data of the apparatus. The first model data is indicative of occurrences of an event of usage of the apparatus matched to respective usage levels. The second model data is indicative of measurement quantities matched to respective remaining usage (RU) quantities. The system further comprises a filter engine, including one or more processors, configured to, based on the first model data, generate a first value indicative of a probability that the RU of the apparatus reached a threshold RU value. The filter engine is further configured to, based on the second model data, generate a second value indicative of a probability of the received measurement data given that the RU of the apparatus reached the threshold RU value. The filter engine is further configured to, based on the first and second values, generate output data that is indicative of a probability that the RU of the apparatus reached the threshold RU value.

In another example embodiment, a computer-implemented method of remaining use estimation is disclosed. The computer-implemented method comprises receiving measurement data of an apparatus. At least a portion of the measurement data is indicative of a level of usage of the apparatus. The computer-implemented method further comprises accessing first and second model data of the apparatus. he first model data is indicative of occurrences of an event of usage of the apparatus matched to respective usage levels. The second model is indicative of measurement quantities matched to respective remaining usage (RU) quantities. The computer-implemented method further comprises, based on the first model data, generating a first value indicative of a probability that the RU of the apparatus reached a threshold RU value given the received measurement data. The computer-implemented method further comprises, based on the second model data, generating a second value indicative of a probability of the received measurement data given that the RU of the apparatus reached the threshold RU value. The computer-implemented method further comprises, by one or more processors and based on the first and second values, generating output data that is indicative of a probability that the RU of the apparatus reached the threshold RU value.

In another example embodiment, a machine-readable storage medium embodying instructions is disclosed. The instructions, when executed by a machine, cause the machine to perform operations comprising receiving measurement data of an apparatus. At least a portion of the measurement data is indicative of a level of usage of the apparatus. The operations further comprise accessing first and second model data of the apparatus. he first model data is indicative of occurrences of an event of usage of the apparatus matched to respective usage levels. The second model is indicative of measurement quantities matched to respective remaining usage (RU) quantities. The operations further comprise, based on the first model data, generating a first value indicative of a probability that the RU of the apparatus reached a threshold RU value given the received measurement data. The operations further comprise, based on the second model data, generating a second value indicative of a probability of the received measurement data given that the RU of the apparatus reached the threshold RU value. The operations further comprise, based on the first and second values, generating output data that is indicative of a probability that the RU of the apparatus reached the threshold RU value.

### Example Embodiments

Reference will now be made in detail to specific example embodiments for carrying out the inventive subject matter. Examples of these specific example embodiments are illustrated in the accompanying drawings. It will be understood that they are not intended to limit the scope of the claims to the described example embodiments. On the contrary, they are intended to cover alternatives, modifications, and equivalents as may be included within the spirit and scope of the disclosure as defined by the appended claims. In the following description, specific details are set forth in order to provide a thorough understanding of the subject matter. Example embodiments may be practiced without some or all of these specific details.

In accordance with the present disclosure, components, process steps, and/or data structures may be implemented using various types of operating systems, programming languages, computing platforms, computer programs, and/or machines. In addition, those of ordinary skill in the art will recognize that other types of devices, such as hardwired devices, field programmable gate arrays (FPGAs), application specific integrated circuits (ASICs), or the like, may also be used without departing from the scope and spirit of the concepts disclosed herein. Example embodiments may also be tangibly embodied as a set of computer instructions stored on a computer readable medium, such as a memory device.

Example systems and methods, embodied on electronic devices, for monitoring apparatuses (also referred to as “components” or “assets”) are described. In the following description, for purposes of explanation, numerous specific details are set forth in order to provide a thorough understanding of example embodiments. It will be evident, however, to one skilled in the art that example embodiments may be practiced without these specific details.

One aspect related to the operation of a system is maintaining the health of the component of the system so that a satisfactory level of performance can be achieved. Eventually, the components of the system will wear down and lose effectiveness or even fail. To account for wear, regular maintenance and replacement can be scheduled. However, such scheduling can be conservative to avoid disastrous or operation-critical events and may not take into account measurement data available at run time. Accordingly, components of the system parts may be replaced more frequently than what would provide healthy operation, which increases costs, incurs delays, and reduces system efficiency

Asset monitoring systems have been developed to estimate RU (e.g., remaining useful life or time to failure) of an asset. Examples of RU can include an amount of use of the asset that is remaining until the asset achieves a condition or state of failure. Failure can correspond to a condition or state of the asset in which the asset has been degraded in way that the asset can no longer perform its function in a satisfactory way. For example, the asset can enter a failure state because of wear such that the asset is no longer reliable (e.g., its error rate is above a predetermined threshold), cannot perform its function, or performs its function at level (e.g., with respect to speed, accuracy, precision, strength, power, and the like) below a predetermined threshold.

Bayesian Filtering in failure prognosis can be employed by estimating degradation and degradation evolution trend parameters. For example, a measure of degradation can be extrapolated until the measure reaches a pre-defined failure threshold. The amount of extrapolation to reach the threshold can be used as an estimate for RU. This approach, however, requires the prior definition of a model of degradation evolution, a failure threshold, and an extrapolation scheme to obtain the times when degradation is expected to reach the threshold. The knowledge of the degradation evolution model and failure threshold for equipment can be limited, as well as costly or time consuming to produce. As a result, obtaining RU estimates by processes that extrapolate degradation evolution until reaching a threshold can pose difficulties.

Hidden Markov Models (HMMs) or Hidden Semi-Markov Models (HSMM) can also be employed in failure prognosis by estimating a sequence of degradation states that evolve until failure. Each degradation state is associated to a fixed probability distribution of time duration so that the remaining duration of the current and future estimated degradation states can be used as an estimate for RU. Defining the different degradation states and transition probabilities and using fixed probability distributions of time associated to each state can pose difficulties.

In example embodiments disclosed herein, asset monitoring systems can directly estimate RU measures instead of using degradation or degradation state evolution estimates. Accordingly, some example embodiments can omit degradation models, failure thresholds, or extrapolation. For example, the prior distribution of RU at each time instant can be obtained by directly manipulating the RU probability distribution obtained in the previous instant. Moreover, a likelihood distribution, which is part of the asset monitoring algorithm, can be associated with the probability of the measurements conditioned to RU values. The probability distributions that will be used to obtain the likelihood can be directly estimated, e.g., from historical measurements. As a result, explicit functions relating the state vector estimates and/or explicit functions associating RU to the measurements can be omitted.

In one example embodiment, the asset monitoring system determines the prior estimate by directly manipulating the estimated RU probability density function (PDF) obtained in the previous time instant. The estimated RU PDF can be a discrete probability distribution. Manipulation of the PDF can comprise translating the PDF curve to adjust the zero-use level to current use level, eliminating the part of the PDF that corresponds to negative RU with respect to the current level of use and normalizing the remainder of the curve so that the area of the PDF is approximately unity.

As such, the prior estimate can be generated without using an explicit function. Initial RU distribution can be obtained from a failure-time distribution, which can be estimated from historical data or reliability studies. In order to obtain the posterior probabilities, the likelihood of available measurements conditioned to the RU can be employed. The probability distribution associated to this likelihood may also be estimated directly from data without using explicit function relating outputs to states. One technical effect is that the asset monitoring system can estimate RU without using failure models based on detailed knowledge of the degradation evolution or failure thresholds. Instead, a set of historical information comprising equipment failure times and measurements performed on this failed equipment at known times can be sufficient information for performing failure prognosis. Even in applications where less historical data is available, but there are reliability models of probability distribution of failure times and tacit/qualitative knowledge on how the measurements (e.g. from inspection or from installed sensors) relate to RU levels, various example embodiments may be employed to generate real-time estimates of the RU value. The referred tacit/qualitative knowledge may be incorporated, for instance, by using fuzzy random variables and defuzzification processes. Failure prognosis problems comprising other characteristics such as multiple failure modes, uncertainty in equipment usage, or varying operating conditions can also be addressed by various example embodiments.

### Overview of Monitoring Systems

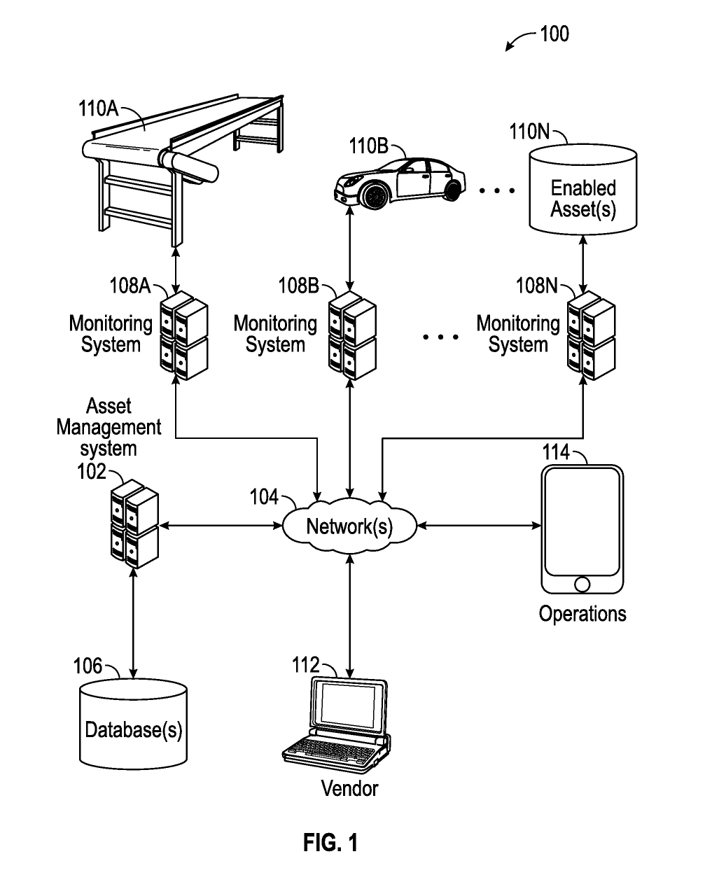

FIG. 1 is a network diagram depicting a client-server system 100, within which one example embodiment may be deployed. In the illustrated example embodiment, an asset management system 102 is interconnected to a network 104 (e.g., the Internet or Wide Area Network (WAN)), a database 106, one or more monitoring systems 108A-N connected to respective enabled assets(s) 110A-N, and user devices 112, 114.

The asset management system 102 can receive measurement data of the enabled assets 110A-N as inputs from the monitoring system and can generate estimates related to the RU of the enabled assets 110A-N as outputs. Examples of assets can include vehicles and manufacturing equipment, as well as any type of machinery, device, apparatus, components thereof, and the like. The monitoring systems 108A-N can include sensors to sense characteristics of the respective enabled assets 110A-N. The monitoring systems 108A-N can provide the measurement data to the asset management system 102 over the network 104. Moreover, the asset management system 102 can transmit control messages to the monitoring systems 108A-N to activate and configure the monitoring systems 108A-N.

As used herein, the parameter tₖ refers to a usage level at time k of an apparatus, such as the enabled assets 110A-N and/or components of the enabled assets 110A-N. Examples of usage tₖ can include time, cycles, flow, rotational or translation distance, and actuation level, as well as rates of change of one or more of like characteristics, and also integrals over time of one or more of the like characteristics. The parameter yₖ refers to measurement data at time k. Measurement data yₖ can include one or more measurements related to usage tₖ, equipment degradation, temperature, vibration, pressure, speed, and/or the like characteristics usable to estimate RU. Measurement data yk can also include inspection data generated by human operators. Inspection data may correspond to a qualitative or fuzzy-valued assessment of the state or operation of the monitored apparatus.

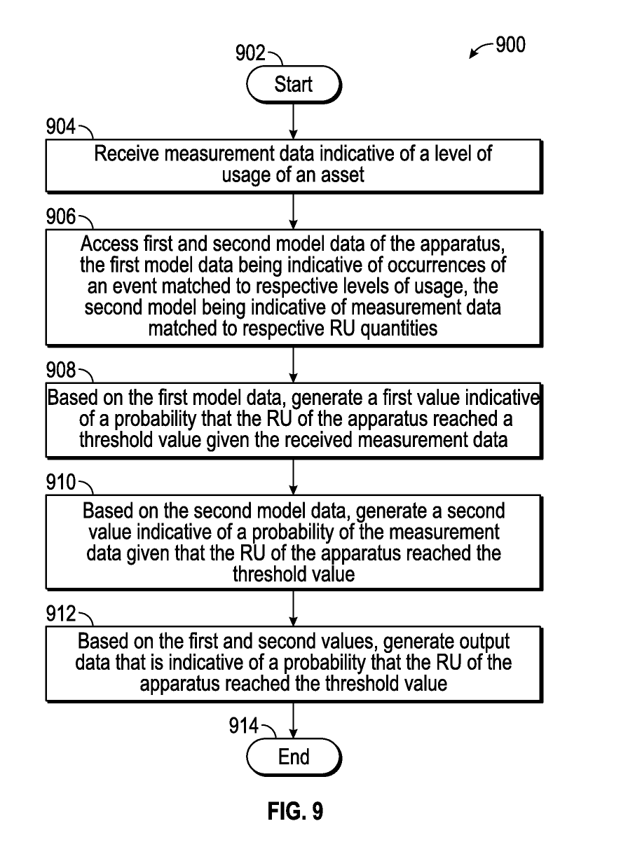

The database 106 can include circuitry and hardware suitable for facilitating data storage. The database 106 can store data that provides data models of the enabled assets 110A-110N. As such, the database can interface with the asset management system 102 to provide data models to the asset management system 102. In an example embodiment, the data models can correspond to models of RU values of the respective devices. One such model can include discrete probabilities of RU values given particular measurement data. Another model can include data of measurement values and RU. For example, the database 106 can include historical data or empirical data relating measurement values to RU values. Yet another model can include data corresponding to equipment reliability (e.g. failure rates and/or future lifetime probabilities), as will be described later in connection with FIG. 9.

In an example embodiment, the database 106 may include a plurality of candidate model data to account for various conditions and operating points of the enabled assets 110A-N. Measurement data may be used to select and/or adjust the model data from the plurality of candidate model data used for estimating RU and/or threshold RUc of remaining use until an event, such as failure.

The user devices 112, 114 can provide client-side functionality to users and can request server-side services from the asset management system 102 and/or the monitoring systems 108A-N. The user devices 112, 114 can correspond to any computing device, such as a desktop computer or laptop computer, as well as other mobile computing devices such as a smart phone, tablet computer, a wearable computing device, and like devices capable of communicating data over the network 104.

The user device 112 can correspond to a vendor client. The vendor client may receive output data from the asset management system 102 for monitoring the health and state of the enabled assets 110A-N. In an example aspect, the user device 112 may automatically replace parts or schedule repair services based on the output data of the asset management system 102.

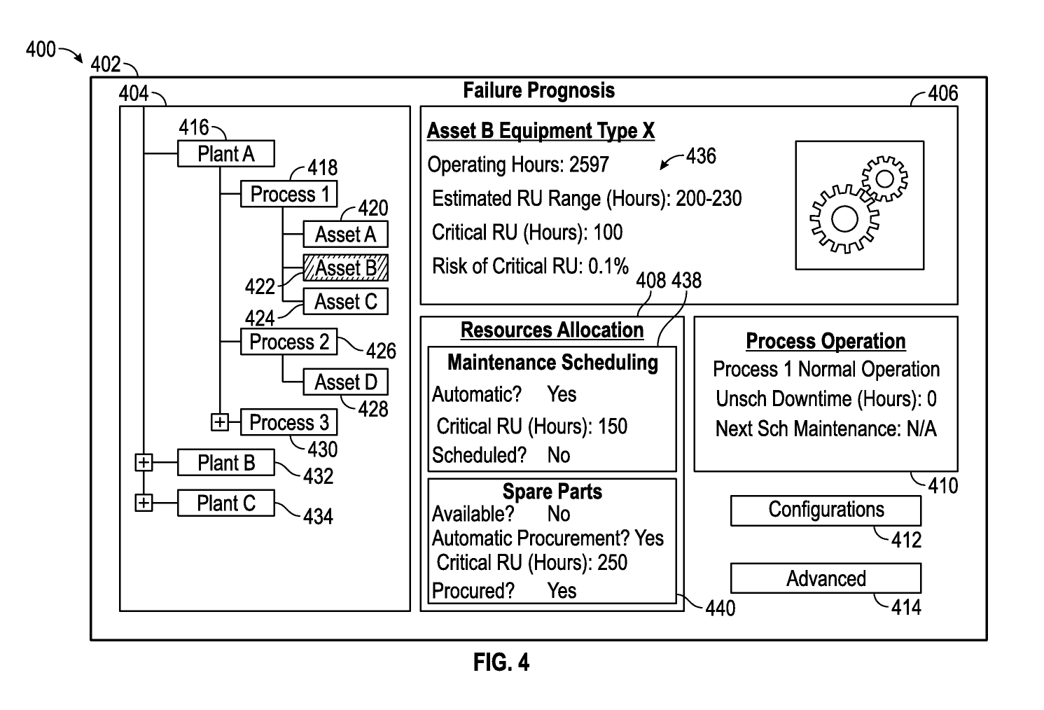

The user device 114 can correspond to an operator client. As such, user device 114 may receive output data from the asset management system 102 for monitoring the health and state of the enabled assets 110A-N. For example, the user device 114 may present a user interface to a user for controlling and configuring the asset management system. An example user interface will be described in detail in connection with FIG. 4. In an example embodiment, the user device 114 may automatically adjust the operation of the enabled assets 110A-N based on the output data of the asset management system 102.

Further, while the system 100 shown in FIG. 1 employs a client-server architecture, the present inventive subject matter is of course not limited to such an architecture, and could equally well find application in a distributed, peer-to-peer, or monolithic architecture system, for example. Each of the monitoring systems 108A-N can host an application providing the functionality of the asset management system 102 so that each of the respective monitoring systems 108A-N implements standalone components, which do not necessarily have networking capabilities.

In addition, while the asset management system 102, the monitoring systems 108A-N, and the user devices 112, 114 have been described above as having separate functionalities, in alternative example embodiments these functionalities may be performed by any one or more of the monitoring systems 108A-N, and the user devices 112, 114.

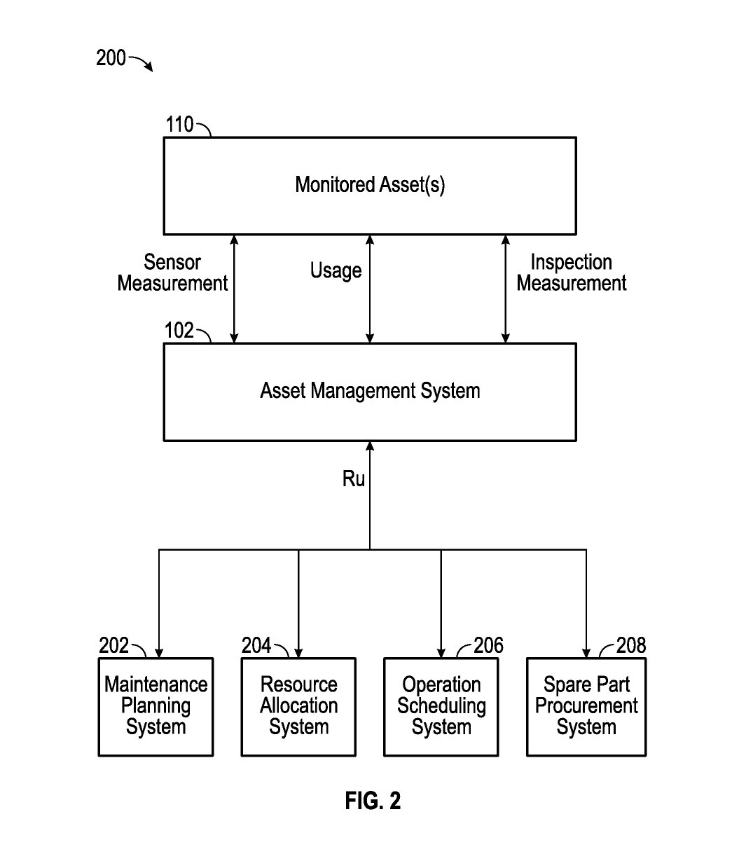

FIG. 2 is a block diagram illustrating a monitoring architecture 200 including multiple applications and components forming at least a portion of the client-server system of FIG. 1, according to an example embodiment. The monitoring architecture 200 can correspond to an application view of the client-server system 100 of FIG. 1.

In the illustrated example embodiment of FIG. 2, the enabled asset(s) 110 are interconnected with the asset management system 102 for communicating measurement data, such as sensor measurements, usage measurements, and/or inspection measurements. The asset management system 102 is communicatively coupled to applications 202-208. In operations, the asset management system 102 can provide output data related to estimated RU levels of the enabled asset(s) 110.

The maintenance planning application 202 may provide a number of maintenance functions and services to the asset management system 102 and/or user devices (e.g., user devices 112, 114 of FIG. 1). For example, based on the RU level, the maintenance planning application 202 may schedule maintenance of the enabled asset(s) 110.

The resource allocation application 204 may provide a number of resource services and functions to the asset management system 102 and/or user devices. For example, the resource allocation application 204 may distribute resources for maintaining a plurality of enabled asset(s) 110 based on the RU level. Examples of resources include, but are not limited to man-hours of mechanics or other workers who will execute maintenance actions, spare parts, consumable parts, tools, testing facilities, or other infra-structure required for performing maintenance actions and the like.

The operation scheduling application 206 may provide a number of scheduling services and functions to the asset management system 102 and/or user devices. For example, the operation scheduling application 206 may schedule operating tasks of a plurality of enabled asset(s) 110 based on RU levels.

The spare part procurement application 208 may provide a number of procurement services and functions to the asset management system 102 and/or user devices. For example, the spare part procurement application 208 may order replacement parts of the enabled asset(s) 110 based on RU levels.

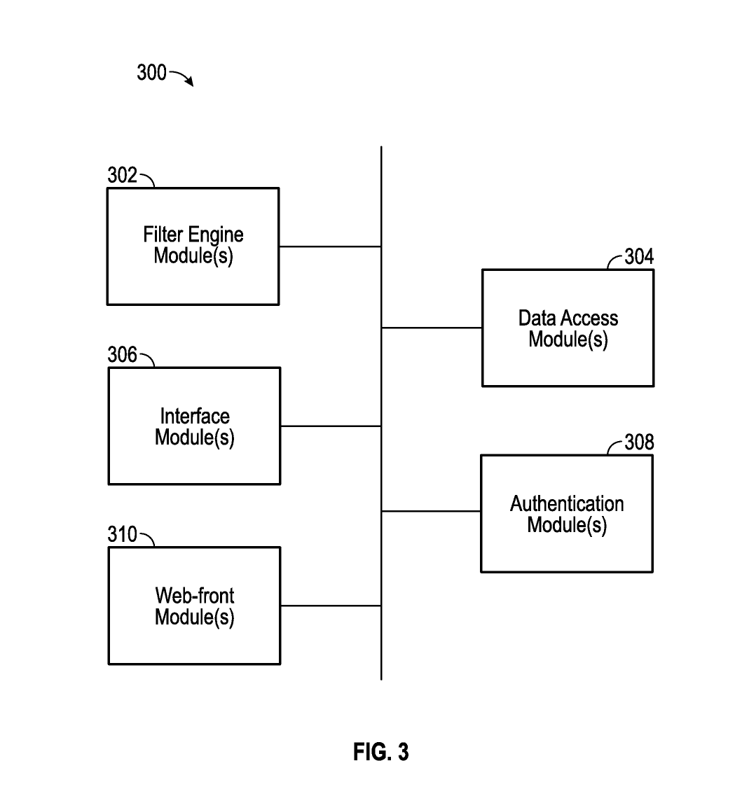

FIG. 3 is a network diagram depicting an example embodiment of an asset monitoring system 300 including multiple modules forming at least a portion of the client-server system 100 of FIG. 1. The modules 302-310 of the illustrated asset monitoring system 300 include a filter engine module(s) 302, a data access module(s) 304, an interface module(s) 306, an authentication module(s) 308, and a web-front module(s) 310. It will be appreciated that alternative example embodiments may include fewer or additional modules.

In some example embodiments, the modules of the asset monitoring system 300 can be included in the asset management system 102 of FIG. 1. However, it will be appreciated that in alternative example embodiments, one or more modules of the asset monitoring system 300 described below can be included, additionally or alternatively, in other devices, such as one or more of the monitoring systems 108A-N or user devices 112, 114 of FIG. 1.

The modules 302-310 of the asset monitoring system 300 may be hosted on dedicated or shared server machines (not shown) that are communicatively coupled to enable communications between server machines. Each of the modules 302-310 are communicatively coupled (e.g., via appropriate interfaces) to each other and to various data sources, so as to allow information to be passed between the modules 302-310 of the asset monitoring system 300 or so as to allow the modules 302-310 to share and access common data. The various modules of the digital asset monitoring system 300 may furthermore access the databases 106.

The asset monitoring system 300 may facilitate monitoring apparatuses, such as the enabled assets 110A-N of FIG. 1. The asset monitoring system 300 may receive measurement data as input and may generate output data related to RU levels. In an example embodiment, the asset monitoring system 300 can generate probabilities of one or more RU levels given measurement data indicative of a level of usage of the monitored apparatus. Additionally or alternatively, the asset monitoring system 300 can generate probabilities of the RU level of the monitored apparatus transitioning to a threshold value RUc. In an example aspect, the asset monitoring system 300 may generate the estimates in substantially real time. By generating estimates of characteristics of the RU level, the asset monitoring system 300 may facilitate efficient monitoring, maintenance, and/or performance of the monitored apparatus.

To this end, the asset monitoring system 300 is shown to include the filter engine module(s) 302, the data access module(s) 304, the interface module(s) 306, the authentication module(s) 308, and the web-front module(s) 310, which may serve to provide estimates related to RU level of a monitored device. For instance, the filter engine module(s) 302 can be a hardware-implemented module which can generate output data related to the RU level by processing measurement data and model data of the monitored apparatus.

The data access module(s) 304 can be a hardware-implemented module which can include or interface with one or more data storage devices, such as the database 106 of FIG. 1, to read or write data.

The interface module(s) 306 may be a hardware-implemented module which may be configured to communicate data with client devices. From the perspective of the asset monitoring system 300, client devices may include user devices, such as the user devices 112, 114 of FIG. 1, and/or monitoring systems, such as the monitoring systems 108A-108N of FIG. 1. For example, the asset monitoring system 300 may support monitoring and estimating services for both the user devices 112, 114 and the monitoring systems 108A-108N. Accordingly, the interface module(s) 306 may present interfaces to the user devices 112, 114 and the monitoring systems 108A-108N, respectively.

In operation of an example embodiment, the interface module(s) 306 can receive measurement data from a monitoring system. The measurement data can include measurement data indicative of a level of usage of the monitored apparatus. The data access module(s) 304 can access first and second model data of the monitored apparatus. The first model data includes discrete probabilities of a first set of respective RU values. In an example aspect, the first model data can serve as a discrete conditional prior probability function p(RUₖ|y_{1:k-1}), wherein RUk represents the RU level at time k, and y_{1:k-1} represents the measurements data for the time interval [1, ₖ₋₁]. Herein, the notation p(X|Y) refers to the conditional probability of X given Y.

The second model data can include measurement data that is matched to a second set of respective RU values. The second model data can correspond to historical data such as testing and/or empirical data of apparatuses of the same type as the monitored apparatus. The filter engine module(s) 302 can process the second model data to generate likelihood functions p(yₖ|RUₖ=i), wherein RUk=i represents that the RUk value is within an interval i=[a, b], as will be described in greater detail.

In an example embodiment, the filter engine module(s) 302 can generate estimates of probabilities of RUₖ being within one or more different intervals given the measurement data y_{1:k}. In particular, the estimates of the probabilities of RUₖ can be generated approximately in accordance with the following equations:

$$\begin{matrix}p ( {RU}_{k} = i \vert {y}_{1 : k} ) = \frac{p ( {y}_{k} \vert {RU}_{k} = i ) p ( {RU}_{k} = i \vert {y}_{1 : k - 1} )}{{\sum }_{j ∈ I} p ( {y}_{k} \vert {RU}_{k} = j ) p ( {RU}_{k} = j \vert {y}_{1 : k - 1} )} , ∀ i ∈ I & ( Eqn . 3.1 ) \\ I = \{ ( {tf}_{min} , {tf}_{min} + {Δ}_{RU} ) , … , ( {tf}_{max} - {Δ}_{RU} , {tf}_{max} ) \} & ( Eqn . 3.2 )\end{matrix}$$

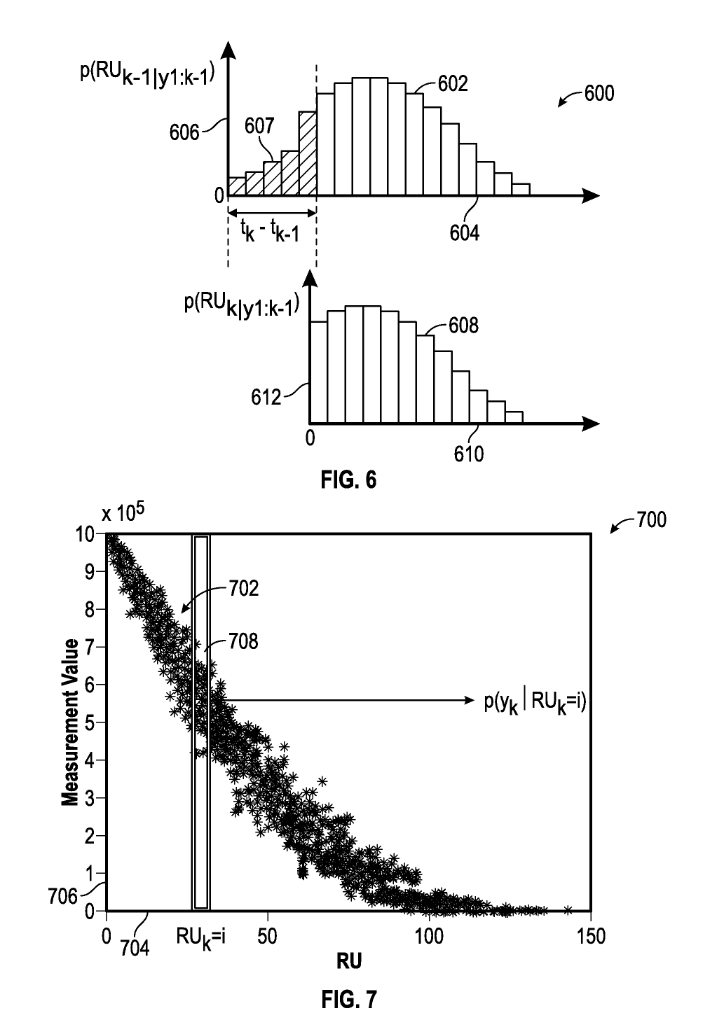

In Equation 3.2, the term Δ_{RU} represents the sample spacing of the discrete prior probability function p(RUₖ|y_{1:k-1}). In an example embodiment, the filter engine module(s) 302 can update the prior probability function p(RUₖ|y_{1:k-1}) based on new measurement data. For example, the filter engine module(s) 302 can update the prior probability function p(RUₖ|y_{1:k-1}) by processing the prior probability function p(RUₖ|y_{1:k-1}) directly based on new measurement data yₖ. An example process will be described in greater detail later in connection with FIG. 6.

The authentication module(s) 308 may be a hardware-implemented module which may facilitate registering devices corresponding to user devices, monitoring systems, and/or enabled assets. For example, the authentication module(s) 308 may receive an authentication request message for authenticating a device. Based on the authentication request message, the authentication module(s) 308 may determine whether the device passes authentication. The authentication module(s) 308 may prevent access to devices that failed authentication.

The web-front module(s) 310 may be a hardware-implemented module which may provide data for displaying web resources on client devices. For example, the asset monitoring system 300 may provide a webpage for users and vendors to log in and create accounts and update account information. The web-front module(s) 310 may provide user interfaces for users to access and/or control the asset monitoring system 300.

### Example User Interface

FIG. 4 is an interface diagram illustrating an example user interface 400 of an asset monitoring application with multiple display elements delivered to a user device of an asset monitoring system 300 of FIG. 3, according to an example embodiment. In the illustrated example embodiment of FIG. 4, the user interface 400 corresponds to a graphical user interface of an asset monitoring system 300. As such, the user interface 400 includes a window 402, which may include frames 404, 406, 408, 410 and control elements 412, 414. The frame 404 includes elements 416-434 for selecting an asset from one or more groups of assets. For example, as shown in FIG. 4, the assets may be organized by plant (e.g., location) and process (e.g., production line or task).

The frame 406 of the window 402 may include a text display 436 for providing runtime information of the selected asset (e.g., asset the associated with the element 422). The text display 436 may include runtime information regarding operating hours, estimated RU level, the critical RU level (e.g., the threshold RU level), and the risk of being in the critical RU state (denoted herein as being in “the threshold state RUc” or “critical state RUc”).

The frame 408 of the window 402 can include sub-frames 438, 440. The sub-frame 438 can include maintenance scheduling information. For example, the sub-frame 438 can include information regarding whether maintenance is automatically scheduled, the critical RU level for scheduling maintenance, and the current status of whether maintenance is scheduled. For instance, if automatic maintenance scheduling is selected, the asset monitoring system 300 can automatically schedule maintenance services when the asset monitoring system 300 estimates that the critical RU level (e.g., 150 operating hours) has been reached.

The sub-frame 440 of the frame 408 can include information regarding spare part procurement. For example the sub-frame 440 can include text providing information regarding whether spare parts are available on-site, whether or not the asset monitoring system 300 is set to automatically order or procure spare parts when the critical RU level is reached, the current setting for the critical RU level for ordering spare parts, and a status indicator of whether or not spare parts were procured.

The frame 410 of the window 402 can include a text display for providing information regarding the process operation history. For example, the frame 410 can provide information regarding the type of operation (e.g., shutdown, reduced operation, normal operation, increased operation, and the like), the amount of unscheduled downtime, and the time of the next scheduled maintenance event.

The control element 412 of the window 402 can be selectable to change the configuration or settings of the asset monitoring system 300. For example, but not of limitation, the user may set the critical RU levels of maintenance scheduling and/or the spare parts procurement, or may turn on or off automatic maintenance scheduling or spare part procurement.

The user interface 400 may be presented on one or more of the components of FIG. 1, such as, but not limited to, the asset management system 102, the monitoring systems 108A-N, and/or the user devices 112, 114.

### Estimating Remaining Usage

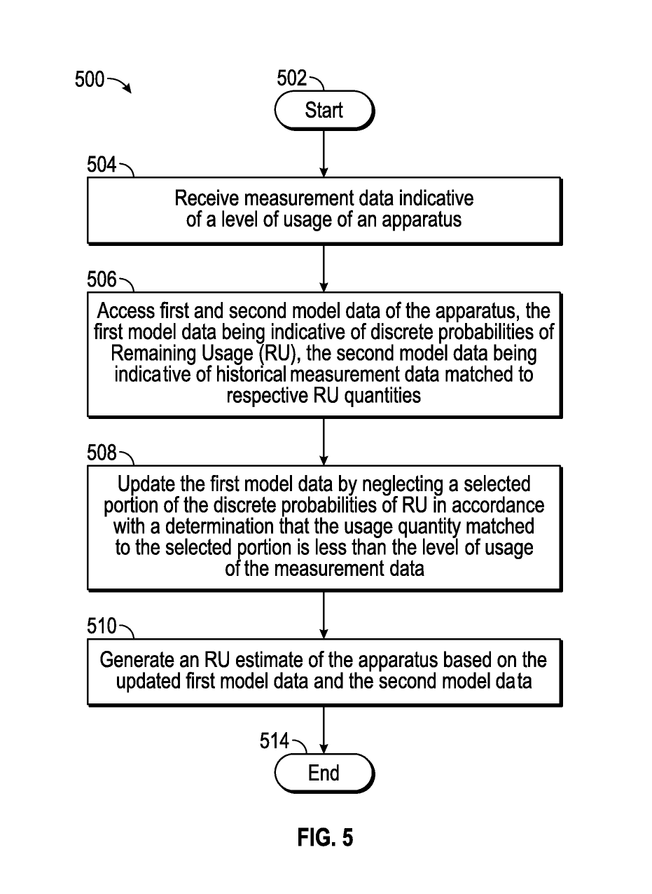

FIG. 5 is a flowchart illustrating an example method 500 of generating an estimate of remaining usage of an asset, in accordance with an example embodiment. In this example, the method 500 may include operations such as receiving measurement data indicative of a level of usage of an apparatus (block 504), accessing first and second model data of the apparatus (block 506), updating the first model data (block 508), and generating an RU estimate (block 510). The example method 500 will be described below, by way of explanation, as being performed by certain modules. It will be appreciated, however, that the operations of the example method 500 may be performed in any suitable order by any number of the modules shown in FIG. 3.

The method 500 starts at block 502 and proceeds to block 504 receiving measurement data yₖ which can include, or be indicative of, a level of usage tₖ of an apparatus. For example, the interface module(s) 306 can receive sensor data from a monitored asset. The measurement data yk can include one or more types of measurements and/or sensor readings. In other words, the measurement data yk can be multivariate. The measurement data yₖ may be provided to the filter engine module(s) 302 for processing.

At block 506, the method 500 includes accessing first and second model data of the apparatus. For example, the data access module(s) 304 can access the first model data that is indicative of discrete probabilities of RU levels. The second model data can be indicative of historical measurement data matched to respective RU quantities. The data access module(s) 304 can provide the first and second model data to the filter engine(s) 302 for processing.

At block 508, the method 500 includes updating the first model data. For example, as will be described in greater detail later in connection with FIG. 6, the filtering engine module(s) 302 can update the first model data by neglecting a selected portion of the discrete probabilities of RU in accordance with a determination that the RU quantities matched to the selected portion is less than approximately zero. In particular, the filter engine module(s) 302 can shift the discrete probabilities according to usage level indicated by the received measurement data. The selected portion can correspond to negative RU values after the shifting process. The remaining values of the updated first model (e.g., the portion corresponding to positive RU levels) are normalized so that the sum of its corresponding discrete probabilities is approximately one. As will be described in greater detail, the second model is used to adjust the discrete probabilities of the updated first model according to current measurements. An example of updating the first model data will be described in greater detail below in connection with FIG. 6

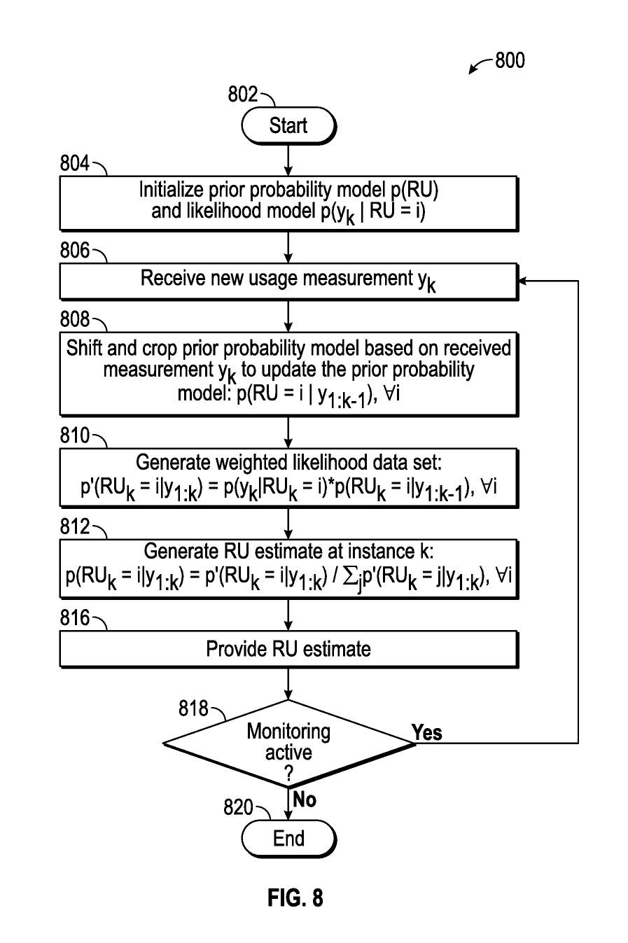

At block 510, the method includes generating an RU estimate of the apparatus. For example, the filtering engine can generate an RU estimate based on the updated first model data and the second model data. An example of generating the RU estimate will be described in greater detail in connection with FIG. 8. At block 514, the method 500 can end.

FIG. 6 is a diagram graphically depicting an example method 600 of processing prior probability model data, according to an example embodiment. In the illustrated embodiment, the curve 602 represents the previous posterior probability of RU conditioned on the previous measurement data (e.g., p(RUₖ₋₁|y_{1:k-1})). The horizontal axis 604 represents RU values. For example, the range of RU values may be covered by the intervals (tfₘᵢₙ, tfₘᵢₙ+Δ_{RU}), (tfₘᵢₙ+Δ_{RU}, tfₘᵢₙ+Δ_{RU}), . . . , (tfₘₐₓ−Δ_{RU}, tfₘₐₓ). The vertical axis 606 represents the probabilities for the RU values of the axis 604.

In operation, the filter engine module(s) 302 updates the posterior probability model of curve 602 to generate the prior probability model represented by the curve 608. For example, at time instant k, the filter engine module(s) 302 may receive measurement data yk which can include an indication of usage level tₖ, where the previous usage level is represented by tₖ₋₁. The filter engine module(s) 302 updates the prior probability model of curve 602 by neglecting the portion 607, which represents the portion of the curve 602 that corresponds to negative RU relative to the usage level tₖ. The portion 607 can be neglected by shifting the curve 602 to the left by a value of tk, cropping out (e.g., deleting or not using) the portion 607, and normalizing the remainder of the curve 602 so that the area under the reminder sums to one (e.g., the shifted and cropped curve 608 has an integral equal to about 1. Accordingly, the curve 608 represents the updated prior probability model data, where the horizontal axis 610 represents the shifted RU values, and the vertical axis 612 represents the probabilities of the shifted RU values.

FIG. 7 is a diagram graphically depicting an example method 700 of selecting likelihood model data, according to an example embodiment. As shown, each of the data points 702 may correspond to a pair of measurement level and RU value. For example, the horizontal axis 704 represents RU values, and the vertical axis 706 represents measurement values y. An interval 708 of RU values can include data points associated with the interval 708 of RU values. As stated, each data point is associated with a respective measurement value y (comprising, for instance, sensor measurements, inspection measurements, and/or the like). Accordingly, data points within the interval 708 represent a distribution of measurement values y conditioned on the selected interval 708 of the RU values. In other words, the distribution of data points 702 within the RU interval 708 can be used for obtaining a model of likelihood function p(y|RUₖ). FIG. 7 shows the measurement y as being one-dimensional (e.g., a single value at a given time instant k) by way of a non-limiting example. It will be appreciated that in alternative example embodiments the measurement y can be multidimensional (e.g., two or more values at a given time instant k), comprising a collection of measurements (e.g. from different sensors and/or inspection inputs). Further elaboration of the likelihood function p(y|RUₖ) will be presented below in connection with FIG. 8.

FIG. 8 is a flowchart illustrating an example method 800 of generating RU estimates, in accordance with an example embodiment. In this example, the method 800 may include operations such as initializing prior probability and likelihood models (block 804), receiving a new measurement data yk (block 806), shifting and cropping the previous posterior probability model based on the evolution of usage to update the prior probability model (block 808), generating weighted likelihood data set based on the received measurement data yk (block 810), generating an RU estimate for the time instance k (block 812), and providing the RU estimate (at block 816). The example method 800 will be described below, by way of explanation, as being performed by certain modules. It will be appreciated, however, that the operations of the example method 800 may be performed in any suitable order by any number of the modules shown in FIG. 3.

The method 800 starts at block 802 and proceeds to block 804 for initializing a prior probability model p(RU₀) and a likelihood model p(y|RU=i). For example, the filter engine module(s) 302 can initialize the prior probability according to the following equation:

$$p ( {RU}_{0} = i ) = \frac{\# components having tf ∈ i}{total \# of failed components} , ∀ i ∈ I \qquad ( Eqn . 8.1 )$$

In Equation 8.1, the set I includes the sub-intervals (tfₘᵢₙ,tfₘᵢₙ+Δ), (tfₘᵢₙ+Δ, tfₘᵢₙ+2Δ), . . . , (tfₘₐₓ−Δ, tfₘₐₓ) of the interval (tfₘᵢₙ, tfₘₐₓ). As stated, t_{f} denotes the time to failure. The right hand side of Equation 8.1 can be obtained from failure data. For example, failure data may correspond to historical failure events or testing results of apparatuses of the same type as the monitored device. The likelihood model p(y|RU=i) can also be obtained from historical data or testing results. The prior probability model p(RU₀) and the likelihood model p(y|RU=i) can be stored in the database(s) 106 of FIG. 1.

At block 806, the method includes receiving a new measurement yₖ. Accordingly, the time index k can be incremented by the asset monitoring system 300. The measurement data yk can be an n-dimensional vector, where n can be one or greater. Each dimension or component of the measurement data yk can correspond to a different measurement or measurement type (e.g., sensor data, inspection data, and/or the like). At each new time instance k, the interface module(s) 306 receives measurement data yₖ from a monitoring system (e.g., monitoring system 108A of FIG. 1) that monitors an enabled asset (e.g., enabled asset 110A). The components of the (multidimensional) measurement data yk can have different sampling rates. The measurement yₖ can include an indication of a level of usage tₖ.

At block 808, the method 800 includes shifting and cropping the prior probability model p(RU) to update the prior probability model based on the measurement data yk. As described in connection with FIG. 6, the filter engine module(s) 302 shifts the previous probability distribution estimate p(RUₖ₋₁=i|y_{1:k-1}) to account for usage evolution since tₖ₋₁. A new set of intervals i may be generated to account for the shifting operation by offsetting the intervals i by tₖ−tₖ₋₁. The portion of the shifted probability distribution that is to the left of the new origin can be cropped or removed. The cropped data represents negative remaining use with respect to the current level of usage tₖ and thus represents unreachable states of the prior probability model p(RUₖ|y_{1:k-1}). The shifted and cropped probability distribution can serve as the updated prior probability model p(RUₖ|y_{1:k-1}). Additionally or alternatively, the shifted and cropped probability distribution can be normalized so that the summation of its points is about unity. In an alternative example embodiment, the updated prior probability model p(RUₖ=i|y_{1:k-1}) is not normalized at block 808, and normalization is instead addressed in a later operation.

At block 810, the method 800 includes generating a weighted likelihood data set. For example, the filter engine module(s) 302 can generate the likelihood models p(yₖ|RU=i) based on current measurement vector yₖ for each i in I from historical data, as described in connection with FIG. 7. Likelihood models can also be retrieved from a database. The filter engine module(s) 302 can generate the likelihood weighted data set according to weighting the updated prior probability models p(RUₖ=i|y_{1:k-1}) by the likelihood models p(y|RU=i) according to the following equations:

p′(RUₖ=i═y_{1:k})=p(yₖ|RUₖ=i)p(RUₖ=i|y_{1:k-1}), ∀iεI (Eqn. 8.2)

In Equation 8.2, the distribution p′(RUₖ=i|y_{1:k}) represents the estimate of the un-normalized posterior probability distribution of RU.

At block 812, the method 800 includes generating an RU estimate at time instance K. For example, the filter engine module(s) 302 can process the likelihood weighted data by multiplying the likelihood weighted data by a normalization factor. For instance, the filter engine module(s) 302 can generate the RU estimate p(RULₖ=i|y_{1:k}) in accordance with the following equation:

$$p ( {RU}_{k} = i \vert {y}_{1 : k} ) = \frac{{p}^{′} ( {RU}_{k} = i \vert {y}_{1 : k} )}{{\sum }_{j} {p}^{′} ( {RU}_{k} = j \vert {y}_{1 : k} )} , ∀ i ∈ I \qquad ( Eqn . 8.3 )$$

In Equation 8.3, the distribution p(RULₖ=i|y_{1:k}) represents the estimate of the posterior probability distribution of RU. In example embodiments, the filter engine module(s) 302 can generate interval estimates [t1, t2] of the RU (e.g., based on a confidence level) or point estimates (e.g., maximum a posteriori, maximum mean value, maximum median value, and/or the like) of the apparatus by processing the RU estimate p(RULₖ=i|y_{1:k}).

At block 816, the method 800 includes providing the RU estimate. For example, the filter engine module(s) 302 can transmit the RU estimate p(RUₖ=i|y_{1:k}) to a client device (e.g., systems 108A-N, or devices 112, 114 of FIG. 1) such as the interface module(s) 306.

In an example embodiment, the filter engine compares the RU estimate with a cost model to determine whether to schedule maintenance of the apparatus. The cost model can include data for scheduling repairs, services, and maintenance (collectively referred to as “maintenance”). In determining whether maintenance should be scheduled, the cost model can factor in the RU estimate, the production load of the apparatus, the cost due to production losses arising from maintenance, the cost for the actual maintenance, RU of other components, and the like. The cost model may weight several of these factors and determine a course of action. In the case that the filter engine determines that maintenance should be scheduled, the interface module(s) 306 can provide a maintenance request message to a client device. As such, the filter engine can reduce costs resulting from untimely maintenance and down time of services facilitated by the apparatus.

In an example embodiment, the filter engine module(s) 302 can compare the RU estimate with a performance model to determine whether the apparatus has degraded performance. For example, degraded performance can include performance below a predetermined threshold. The interface module(s) 306 can provide a control message to a client device to reduce use of the apparatus in accordance with a determination that the apparatus has degraded performance. Degraded performance can result in unsafe conditions or inefficient performance. Reducing or otherwise adjusting the use of the apparatus can improve safety and/or efficiency.

At decision block 818, the method 800 includes determining whether monitoring is active. For example, the method 800 repeats blocks 806-816 while monitoring is active. Otherwise, the method 800 ends at block 820.

### Estimating a Threshold State of Remaining Use

In an example embodiment, the asset monitoring system 300 receives measurement data that is indicative of a level of usage of an enabled asset and generates an output that is indicative of a probability that the monitored asset is in a threshold state RUc (or referred to as a “critical” state). The term critical state as used herein can refer to a state associated with a threshold level RUc and which the monitoring system 300 monitors. Moreover, detection of a critical state can invoke a response by the monitoring system 300. An example of a threshold state RUc is a level of RU that is a threshold away from an expected time to failure (TTF) or time to event (TTE). In example embodiments, the asset monitoring system 300 may detect two states, such as the monitored asset being in a critical state or not being in a critical state (“non-threshold state”). In other example embodiments, the asset monitoring system 300 may detect more than two states, such as, but not limited to, critical state, a warning state, and a healthy state. Each state can be associated with a range of RU levels. The asset monitoring system 300 can respond according to the detected state. Accordingly, one technical effect is that the asset monitoring system 300 may serve to facilitate intelligent operation of monitored assets by automatically scheduling maintenance, controlling operation (such as reducing workload), ordering new parts, and the like.

By way of further description, it may be advantageous to know that some critical TTE level has been reached. This can be the case, for instance, in failure prognosis: if it is known that an RU level is lower than a threshold value, parts can be ordered and/or maintenance can be scheduled and performed at convenient or economically desirable times. Other examples of applications where knowledge that a critical TTE level has been reached can be useful include forecasting of natural events, forecasting of economic related events, forecasting of vehicle arrival events. In example embodiments, one advantage, among others, is that no state evolution model, threshold, or extrapolation is needed. For example, the value of one state is estimated. This can be a discrete state which, in a simple form of the solution, can assume two values: one indicating that TTE is not critical and the other indicating that it is critical. As used herein, critical can refer to reaching a threshold value. As stated, in alternative example embodiments, additional or fewer threshold values can be used to account for different states corresponding to different responses by the asset monitoring system 300.

Estimation of the threshold state can be performed iteratively, with each iteration corresponding to: (1) first a prior estimate of the current state value obtained based on the estimate resulting from the previous iteration; and (2) information from current measurements incorporated to adjust this prior estimate, thereby producing a posterior estimate.

In example embodiments, the prior estimate can be obtained from a future lifetime probability distribution of the population, and the likelihood functions for incorporating the measurements are obtained by evaluating statistics of historical measurements grouped by TTE criticality level. In some example embodiments, the asset monitoring system 300 can generate estimates from data sets based on relatively few run-to-failure data points.

FIG. 9 is a flowchart illustrating an example method of monitoring a threshold state of RU, in accordance with an example embodiment. In this example, the method 900 may include operations such as receiving measurement data of a monitored asset (block 904), accessing first and second model data of the apparatus (block 906), generating a first value that is indicative of a prior probability that the RU of the apparatus has reached a threshold value (block 908), generating a second value indicative of a probability of the received measurement data given that the RU of the apparatus reached the threshold value (block 910), and generating output data that is indicative of a probability that the RU of the apparatus reached the threshold value (block 912).

In an example embodiment, the method 900 can generate prior probabilities and likelihood values for each of one or more states. For example, the method 900 can generate prior-probability and likelihood values for a non-threshold state, a first threshold state, a second threshold state, and so on. It will be appreciated that the number of states can correspond to any suitable number based on application-specific considerations. Accordingly, the output data can include the posterior probabilities that the apparatus is in each of the states.

The example method 900 will be described below, by way of explanation, as being performed by certain modules. It will be appreciated, however, that the operations of the example method 900 may be performed in any suitable order by any number of the modules shown in FIG. 3.

The method 900 starts at block 902 and proceeds to block 904 for receiving measurement data. For example, the asset monitoring system 300 may receive the measurement data using the interface module(s) 306. The measurement data may include data related to one or more of sensor measurements, usage levels, or inspection measurements of a monitored apparatus (e.g., one of the enabled asset 110A-N).

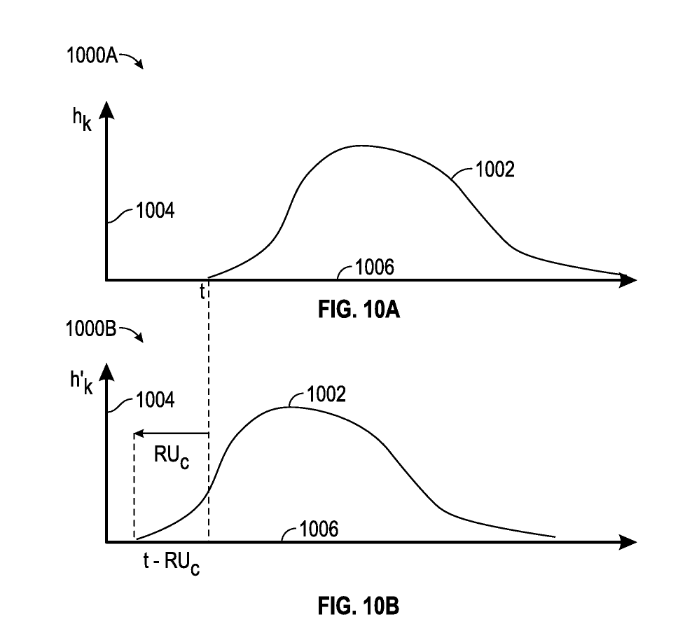

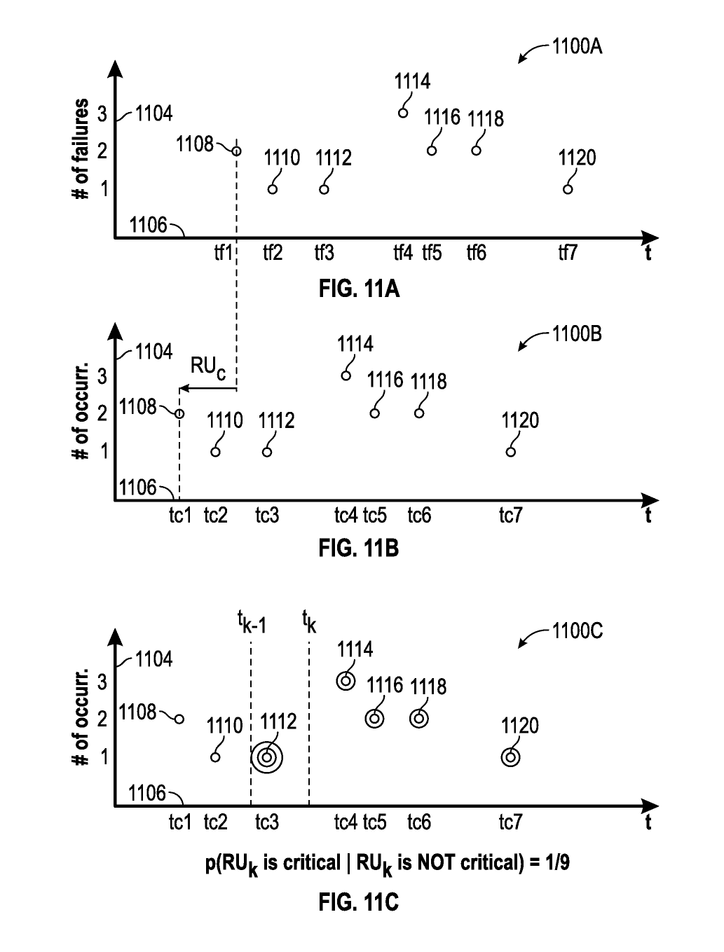

At block 906, the method 900 includes accessing first and second model data of the apparatus. For example, the filter engine module(s) 302 can access the first and second model data in response to the interface module(s) 306 receiving the measurement data. In an example embodiment, the first model data can be data that is indicative of occurrences of an event matched to respective levels of usage. The first model data can be testing or historical data that empirically relates levels of usage to occurrences of the event. By way of a non-limiting example, the event can correspond to a failure event or a malfunction event. For instance, the first data model can correspond to a future lifetime probability distribution (or a future critical time probability distribution) indicative of failure rates of the apparatus, as will be described below in connection with FIGS. 10A, 10B, and 11A-C. In alternative example embodiments, the event can correspond to any event corresponding to a responsive action related to the operation of the monitored asset or apparatus. The second model data can include data that is indicative of measurement levels matched to respective RU levels, as was described above in connection with FIG. 7.

The first and second model data can be stored in a data storage device, such as the database 106 of FIG. 1. The filter engine module(s) 302 can use the data access module(s) 304 to access the first and second model data.

At block 908, the method 900 includes generating a first value that is indicative of a prior probability that the RU of the apparatus has reached a threshold value. The first value can represent a prior probability calculation. Example methods of generating the first value will be described in greater detail in connection with FIGS. 10A, 10B, 11A-C, and 13.

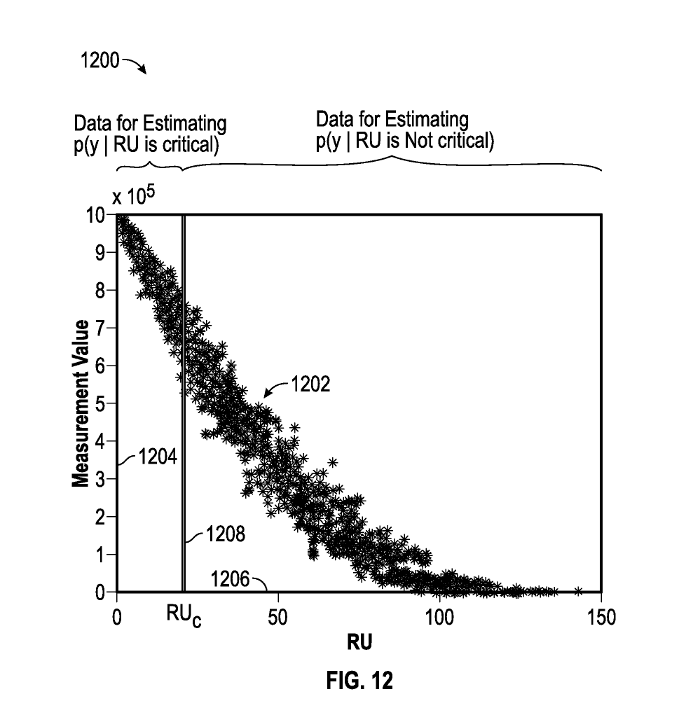

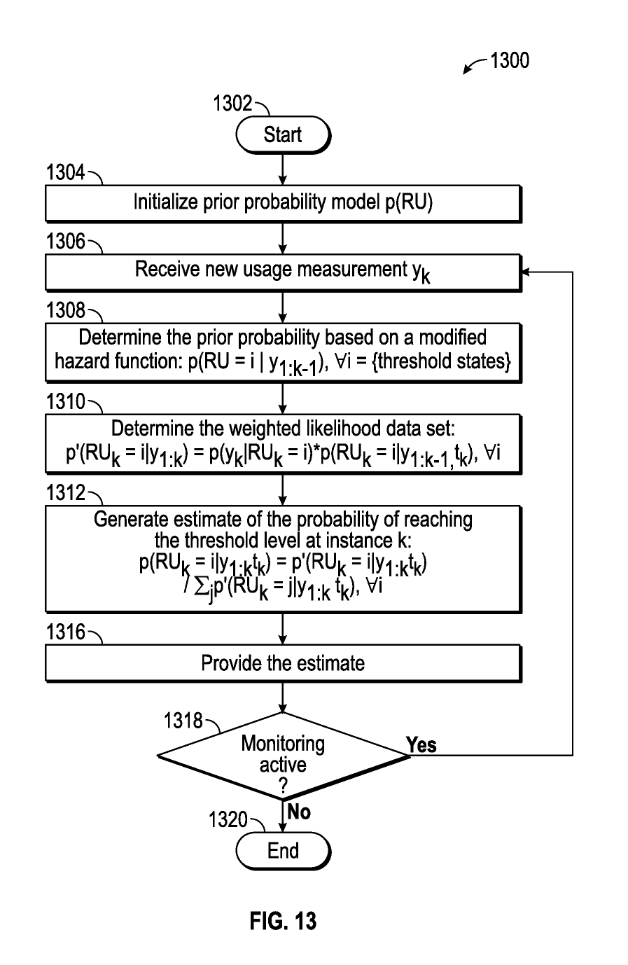

At block 910, the method 900 includes generating a second value that is indicative of a probability of the measurement data given that the RU of the apparatus reached the threshold value. In other words, the second value corresponds to the likelihood that an apparatus of the type of the monitored asset that has reached the threshold value would have generated the received measurement data. In an example embodiment, the method 900 generates likelihood values that the apparatus has reached one or more states. For example, the method 900 can generate likelihood values that the apparatus is in a non-threshold state, a first threshold state, a second threshold state, and so on. Example methods of generating the second value will be described in greater detail in connection with FIGS. 12 and 13.

At block 912, the method includes generating output data that is indicative of a probability that the RU of the apparatus reached the threshold value RUc. An example method of generating the output data will be described in greater detail in connection with FIG. 13. At block 914, the method 900 can end.

FIGS. 10A and 10B are plots 1000A, 1000B, respectively, that graphically depict an example method of generating prior probability model data, according to an example embodiment. FIGS. 10A and 10B share common reference indicia, and only differences between the figures are described herein for the sake of brevity. The example method will be described below, by way of explanation, as being performed by certain modules. It will be appreciated, however, that the operations of the example method may be performed in any suitable order by any number of the modules shown in FIG. 3.

The plot 1000A includes a curve 1002, a vertical axis 1004, and a horizontal axis 1006. The curve 1002 corresponds to a future lifetime PDF hₖ that corresponds to the probability density of an apparatus failing in the future (t>tₖ) given that it has not failed up to usage level tₖ. For example, a vertical axis 1004 represents failure rate or relative number of failed devices (increasing in the positive vertical direction), and the horizontal axis 1006 represents time or usage levels (increasing in the positive vertical direction). Accordingly, over a particular interval along the horizontal axis 1006, the area under the curve 1002 can represent a probability of a failure or event during that interval. The future lifetime PDF hₖ can be derived from historical data (e.g., testing data) associated with failure times of similar apparatuses. Suspension data (e.g., data corresponding to lifetime of equipment which has not yet failed) can also be used when deriving future lifetime PDF hₖ. The future lifetime PDF can also be obtained from any suitable method employed in equipment reliability analysis. It will be appreciated that the shape of the curve 1002 shown in FIG. 10A is presented by way of illustration and is not limiting. In alternative example embodiments, the curve 10002 can have different shapes in accordance with the particular failure characteristics.

The plot 1000B illustrates a “future critical time PDF h′ₖ” represented by the curve 1002. In particular, relative to FIG. 10A, the curve 1002 of FIG. 10B has been shifted to the left by a value RUc, which represents the RU value defining the threshold state or critical state. Accordingly, the future critical time PDF h′ₖ can be indicative of rates to achieve the threshold state RUc with respect to the level of usage represented by the horizontal axis 1006. Integrating a region under the curve 1002 of plot 1000B can provide an estimate of the probability that the apparatus will transition from a non-threshold state to a threshold state RUc during that period, as will be described below in connection with FIGS. 11A-C.

FIGS. 11A-C are plots 1100A-C, respectively, that graphically depict an example method of generating prior probability model data, according to an example embodiment. FIGS. 11A-C share common reference indicia, and only differences between the Figures are described herein for the sake of brevity. The example method will be described below, by way of explanation, as being performed by certain modules. It will be appreciated, however, that the operations of the example method may be performed in any suitable order by any number of the modules shown in FIG. 3.

In FIG. 11A, the plot 1100A includes a vertical axis 1104, a horizontal axis 1106, and data points 1108-1120. The vertical axis 1104 represents a number of failure incidents. The horizontal axis 1106 represents usage levels. The levels of usage tf1, tf2, . . . , tf7 represent levels of usage that led to an apparatus failing (e.g., a “time to failure” measure). The data points 1108-1120 can represent the number of historical or empirical failure events for apparatuses of the type of the monitored apparatus. As such, each of the data points 1108-1120 represents the number of incidents of failure for the respective levels of usage tf1, tf2, . . . , tf7. For example, at the level of usage tf1, the data point 1108 represents that two apparatuses of the data set had failed.

Turning to FIG. 11B, the plot 1100B includes the data points 1108-1120 of FIG. 11A shifted to the left by the value RUc to account for a threshold state (accordingly, the term RUc can be referred to as the threshold state). As such, the vertical axis 1104 now represents the number of occurrences of an apparatus transitioning from a non-threshold state to a threshold state RUc. Moreover, the horizontal axis 1106 includes levels of usage tc1, tc2, . . . , tc7 that represent RU levels that resulted in apparatuses transitioning to the threshold state RUc (e.g., the corresponding apparatuses that failed within an RUc amount of usage). Accordingly, the usage levels tc1, tc2, . . . , tc7 can be related to the levels of usage tf1, tf2, . . . , tf7 by shifting the levels of usage tf1, tf2, . . . , tf7 to the left by the value RUc:

t_{ci}=t_{fi}−RU_{c}, i=1, . . . ,7 (Eqn. 11.1)

Accordingly, each of the data points 1108-1120 of the plot 1100B represents the number of incidents of an apparatus transitioning to the threshold state RUc at the usage levels tc1, tc2, . . . , tc7. For example, in the context of FIG. 11B, the data point 1108, which is now matched to tc1, represents that at usage level tc1 there were two incidents of apparatuses transitioning to the threshold state RUc.

Turning to FIG. 11C, the future critical time PDF h′ₖ; can be used to estimate a probability of a monitored apparatus that is in a non-threshold state transitioning to the threshold state RUc over, for example, a usage period (tₖ₋₁, tₖ). This type of probability can be referred to as a state-transition probability p_{0c}^{[t}^{ₖ₋₁}^{,t}^{ₖ}^{]}. In an example embodiment, the usage level tₖ can be the usage levels indicated by the current measurement data yₖ, and tₖ₋₁ can be the usage level indicated by the previous measurement data yₖ₋₁. The filter engine module(s) 302 can determine the state-transition probability, in part, by using the future critical time PDF h′ₖ to determine a ratio of the number of apparatuses that transitioned from a non-threshold state to the threshold state RUc during the interval (tₖ₋₁, tₖ) to the number of apparatuses that are in the non-threshold state at usage level tₖ₋₁ or greater. To this end, the filter engine module(s) 302 can sum h′ₖ over (tₖ₋₁, tₖ) to determine the number of apparatuses that transition from a non-threshold state to a threshold state over (tₖ₋₁, tₖ). Furthermore, the filter engine module(s) 302 can sum h′ₖ over usage levels of tₖ₋₁ or greater to determine the number of apparatuses that are in the non-threshold state at the usage level tₖ₋₁. Accordingly, the state-transition probability p_{0c}^{[t}^{ₖ₋₁}^{,t}^{ₖ}^{]} can be determined based on the future critical time PDF h′ₖ according to the following equation:

$${p}_{0 c}^{[ {t}_{k - 1} , {t}_{k} ]} = {\int }_{{t}_{k - 1}}^{{t}_{k}} {h}_{k - 1}^{′} d t ≅ \frac{\# times {RU}_{c} was reached between {t}_{k - 1} and {t}_{k} }{\# times {RU}_{c} was reached at {t}_{k - 1} or later} \qquad ( Eqn . 11.2 )$$

In the illustrated example embodiment of FIG. 11C, the numerator of the right-hand side term of equation 11.2 is equal to the incident value of data point 1112, which is 1. The denominator of the right-hand side term of equation 11.2 is equal to the incident values of the data point 1112-1120, which is 9. Accordingly, in the example, the state-transition probability p_{0c}^{[t}^{ₖ₋₁}^{,t}^{ₖ}^{]} (or, e.g., the conditional prior probability p(RUₖ₋₁<RU_{c}|RUₖ₋₁>RU_{c})) can be modeled as having a value of 1/9.

FIG. 12 is a plot 1200 graphically depicting an example method of generating likelihood model data, according to an example embodiment. As shown, each of the data points 1202 may correspond to a pair of measurement level and RU value. The data points 1202 are plotted on the horizontal axis 1204, which represents RU values, and the vertical axis 1206, which represents measurement levels. The measurement levels can be indicative of usage levels. The data points 1202 are partitioned into two portions by the threshold value RUc, represented by the line 1208. That is, the data points 1202 that correspond to RU less than the threshold RUc can be used to generate a distribution for the likelihood function p(y|RU<RUc), which can represent the probability that an apparatus in a non-threshold state has generated the measurement y. Moreover, the data points 1202 that correspond to a value of RU that is less than the threshold RUc can be used to generate a distribution for the likelihood function p(y|RU>RUc), which can represent the probability that an apparatus in a threshold state RUc has generated the measurement y. Further elaboration of the likelihood functions p(y|RU<RU_{c}) and p(y|RU>RU_{c}) will be presented below in connection with FIG. 13.

FIG. 12 shows the measurement level as being one-dimensional (e.g., a single value at a given time instant k) by way of a non-limiting example. It will be appreciated that in alternative example embodiments the measurement level can be multidimensional (e.g., two or more values at a given time instant k), comprising a collection of measurements (e.g. from different sensors and/or inspection inputs).

FIG. 13 is a flowchart illustrating an example method 1300 of generating estimates of a monitored apparatus being in a non-threshold state or one or more threshold states RUc, in accordance with an example embodiment. The estimates can be probabilistic estimates indicating a level of probability that the apparatus is in the threshold state RUc. In an alternative example embodiment, the estimates can correspond to binary decisions on whether the apparatus is in the threshold state or not. The monitored apparatus can correspond to one of the enabled assets 110A-N of FIG. 1.

In this example, the method 1300 may include operations such as initializing a prior probability model p(RU₀=i), for “i” equal to all possible threshold and non-threshold states (block 1304), receiving a new usage measurement data yk (block 1306), determining the prior probability based on a future critical time PDF (block 1308), determining a weighted likelihood data set (block 1310), generating an estimate of the probability of reaching a threshold level (block 1312), and providing the estimate (block 1316). In an example embodiment, the method 1300 may repeat these operations in response to receiving a new usage measurement. The example method 1300 will be described below, by way of explanation, as being performed by certain modules. It will be appreciated, however, that the operations of the example method 1300 may be performed in any suitable order by any number of the modules shown in FIG. 3.

The method 1300 starts at block 1302 and proceeds to block 1304 for initializing a prior probability model p(RU_{c}). For example, the filter engine module(s) 302 can initialize according to p(RU₀<RU_{c})=eps, where eps is small (e.g., approximately zero but positive number) value. This initialization can serve to indicate that the monitored apparatus is initially in a non-threshold state.

At block 1306, the method 1300 includes receiving a new measurement data yk. Accordingly, the time index k can be incremented by the asset monitoring system 300. For example, at each time instance k, the interface module(s) 306 receives measurement data yₖ from a monitoring system (e.g., a corresponding monitoring system 108A-N of FIG. 1) that monitors the monitored apparatus. For each time instant k, the measurement data yk may be a single measurement or multiple measurements (e.g., the measurement data yk can be multivariate or multidimensional). The measurement data yₖ can include indications of a level of usage tₖ. For example, the filter engine module(s) 302 receives the measurement data yₖ and, if needed, determines a level of usage tₖ from the measurement data yₖ. For example, in some example embodiments, the filter engine module(s) 302 converts the measurement data yₖ from a first quantity to a second quantity to generate tₖ. For instance, the measurement data yₖ may represent characteristics such as revolutions per minute (RPM) measurements, and the filter engine module(s) 302 can convert the RPM measurement to a total number of revolutions during operation. It will be appreciated that any suitable first and second quantities can be used in alternative example embodiments.

At block 1308, the method 1300 includes determining a prior probability p(RUₖ<RU_{c}|y_{1:k-1},tₖ) that the monitored apparatus is in the threshold state RUc and/or a prior probability p(RUₖ>RU_{c}|y_{1:k-1},tₖ) that the monitored apparatus is in a non-threshold state. For example, the filter engine module(s) 302 can generate the prior probability p(RUₖ<RU_{c}|y_{1:k-1},tₖ) based at least on the previous posterior probability p(RUₖ₋₁>RU_{c}|y_{1:k-1},tₖ₋₁) that the monitored apparatus was in the non-threshold state given the previous measurement data yₖ₋₁ and the previous usage level tₖ₋₁, weighted by a state-transition probability p_{0c}^{[t}^{ₖ₋₁}^{,t}^{ₖ}^{]} of the monitored apparatus transitioning from the non-threshold state to the threshold state during the usage interval [tₖ₋₁, tₖ], which is combined with the previous posterior probability p(RUₖ₋₁<RU_{c}|y_{1:k-1},tₖ₋₁) that the monitored apparatus was previously in the threshold state RUc given the previous measurement and usage data yₖ₋₁, tₖ₋₁. In particular, the filter engine module(s) 302 can determine the current prior probability p(RUₖ<RU_{c}|y_{1:k-1},tₖ) according to the following equation:

p(RUₖ<RU_{c}|y_{1:k-1},tₖ)=p(RUₖ₋₁>RU_{c}|y_{1:k-1},tₖ₋₁)p_{0c}^{[t}^{ₖ₋₁}^{,t}^{ₖ}^{]}+p(RUₖ₋₁<RU_{c}|y_{1:k-1},tₖ₋₁) (Eqn. 13.1)

The filter engine module(s) 302 can determine the state-transition probability p_{0c}^{[t}^{ₖ₋₁}^{,t}^{ₖ}^{]} based on historical data of the monitored event (e.g., failure). In one example embodiment, the filter engine module(s) 302 determines the state-transition probability p_{0c}^{[t}^{ₖ₋₁}^{,t}^{ₖ}^{]} based on a future lifetime PDF h′ₖ or a future critical time PDF h′ₖ. The filter engine module(s) 302 process the future critical time PDF h′ₖ in a manner as described in connection with FIGS. 10A, 10B, and 11A-C to determine the state-transition probability p_{0c}^{[t}^{ₖ₋₁}^{,t}^{ₖ}^{]}. For example, in an example embodiment, the state transition probability p_{0c}^{[t}^{ₖ₋₁}^{,t}^{ₖ}^{]} can be determined from the future critical time PDF h′ₖ in accordance with the following equations:

$${p}_{0 c}^{[ {t}_{k - 1} , {t}_{k} ]} = {\int }_{{t}_{k - 1}}^{{t}_{k}} {h}_{k - 1}^{′} d t ≅ \frac{\# times {RU}_{c} was reached between {t}_{k - 1} and {t}_{k} }{\# times {RU}_{c} was reached at {t}_{k - 1} or later} \qquad ( 13.2 )$$

Furthermore, the filter engine module(s) 302 can generate the prior probability p(RUₖ>RU_{c}|y_{1:k-1},tₖ) based at least on the previous posterior probability p(RUₖ>RU_{c}|y_{1:k-1},tₖ₋₁) that the monitored apparatus was in the non-threshold state given the previous measurement data yₖ₋₁, the previous usage level tₖ₋₁, and the state-transition probability p_{0c}^{[t}^{ₖ₋₁}^{,t}^{ₖ}^{]}. In particular, the filter engine module(s) 302 can determine the current prior probability p(RUₖ>RU_{c}|y_{1:k-1},tₖ) according to the following equation:

p(RUₖ>RU_{c}|y_{1:k-1},tₖ)=p(RUₖ₋₁>RU_{c}|y_{1:k-1},tₖ₋₁)(1−p_{0c}^{[t}^{ₖ₋₁}^{,t}^{ₖ}^{]}) (13.3)

In equation 13.3, the term 1−p_{0c}^{[t}^{ₖ₋₁}^{,t}^{ₖ}^{]} represents the probability of the monitored apparatus not transitioning from the non-threshold state to the threshold state during the usage interval [tₖ₋₁, tₖ].

At block 1310, the method 1300 includes determining a likelihood weighted data set. For example, the filter engine module(s) 302 can generate the likelihood weighted data set p′(RUₖ<RU_{c}|y_{1:k},tₖ) and p′(RUₖ>RU_{c}|y_{1:k},tₖ) according to the following equations:

p′(RUₖ<RU_{c}|y_{1:k},tₖ)=p(yₖ|RU<RU_{c})p(RUₖ<RU_{c}|y_{1:k-1},tₖ) (Eqn. 13.4)

p′(RUₖ>RU_{c}|y_{1:k},tₖ)=p(yₖ|RU>RU_{c})p(RUₖ>RU_{c}|y_{1:k-1},tₖ) (Eqn. 13.5)

At block 1312, the method 1300 includes generating an estimate of a probability of reaching the threshold state. For example, the filter engine module(s) 302 can generate the estimated probabilities p(RUₖ<RU_{c}|y_{1:k},tₖ) and p(RUₖ>R_{c}|y_{1:k},tₖ) according to the follow equations:

$$\begin{matrix} p ( {RU}_{k} < {RU}_{c} \vert {y}_{1 : k} , {t}_{k} ) = \frac{{p}^{′} ( {RU}_{k} < {RU}_{c} \vert {y}_{1 : k} , {t}_{k} )}{{N}_{0}} & ( Eqn . 13.6 ) \\ p ( {RU}_{k} > {RU}_{c} \vert {y}_{1 : k} , {t}_{k} ) = \frac{{p}^{′} ( {RU}_{k} > {RU}_{c} \vert {y}_{1 : k} , {t}_{k} )}{{N}_{0}} & ( Eqn . 13.7 ) \\ {N}_{0} = {p}^{′} ( {RU}_{k} < {RU}_{c} \vert {y}_{1 : k} , {t}_{k} ) + {p}^{′} ( {RU}_{k} > {RU}_{c} \vert {y}_{1 : k} , {t}_{k} ) & ( Eqn . 13.8 )\end{matrix}$$

In Equations 13.6-8, the term NO can serve as a normalization factor so that the PDF p(RU|y_{1:k},tₖ) sums to approximately unity over all RU states.

At block 1316, the method 1300 includes providing output data based on the estimates p(RUₖ<RU_{c}|y_{1:k},tₖ) and/or p(RUₖ<RU_{c}|y_{1:k},tₖ). For example, the filter engine module(s) 302 can provide the estimate to a client device, such as user devices 112, 114 or to a component of the asset management system 102of FIG. 1, or to any of the applications 202-208 of FIG. 2. The output data can include the estimates p(RUₖ<RU_{c}|y_{1:k},tₖ) and/or p(RUₖ<RU_{c}|y_{1:k},tₖ). Additionally or alternatively, the output data can include binary decisions as to whether the apparatus is in the threshold state RUc or not. In an example embodiment, the filter engine module(s) 302 can compare the estimates p(RUₖ<RU_{c}|y_{1:k},tₖ) and/or p(RUₖ<RU_{c}|y_{1:k},tₖ) and select the state that has the higher probability.

The method 1300 was described above, by way of a non-limiting example, as the filter engine module(s) 302 generating output data related to two states: the non-threshold state and the threshold state. It will be appreciated that in alternative example embodiments the filter engine module(s) 302 can generate output data corresponding to more than two states. For example, the output can include data indicative of p(RUₖ<RU_{c}|y_{1:k},tₖ) for each state “i” (each threshold and non-threshold states).

Additionally or alternatively, the output data can include control messages to request a responsive action based on the estimates p(RUₖ<RU_{c}|y_{1:k},tₖ) and/or p(RUₖ<RU_{c}|y_{1:k},tₖ). In an example embodiment, the output data can be compared with a predetermined threshold, and maintenance of the monitored apparatus can be scheduled in accordance with a determination that the output data is less than the predetermined first threshold. For example, the filter engine module(s) 302 can compare a predetermined threshold Th_{P} and the estimate of the probability p(RUₖ<RU_{c}|y_{1:k},tₖ) that monitored apparatus is in the threshold state. In the case that the probability p(RUₖ<RU_{c}|y_{1:k},tₖ) is less than the threshold Th_{P}, the filter engine module(s) 302 can provide an application 202-208 to perform an action, such as order a new part, schedule maintenance, adjust operation/scheduling, and/or the like.

In an example embodiment, the threshold Th_{P} and, additionally or alternatively, the threshold state RUc can be determined from a cost model to determine whether to schedule maintenance of the apparatus. The cost model can include data for scheduling repairs, services, and maintenance (collectively referred to as “maintenance”). In determining whether maintenance should be scheduled, the cost model can factor in the production load/operation schedule of the apparatus, the cost due to production losses arising from maintenance, the cost of the actual maintenance service (e.g., costs associated with labor and parts), RU of other components, and the like. The cost model may weigh several of these factors and determine a course of action based on the weighted combination of the factors. In the case that the filter engine determines that maintenance should be scheduled, the interface module(s) 306 can provide a maintenance request message to a client device. As such, the filter engine can reduce costs resulting from untimely maintenance and down time of services facilitated by the apparatus.

In an example embodiment, the threshold Th_{P} and, additionally or alternatively, the threshold state RUc, can be determined from a performance model to determine whether the apparatus has degraded performance. For example, degraded performance can include performance below a predetermined threshold. The interface module(s) 306 can provide a control message to a client device to reduce use of the apparatus in accordance with a determination that the apparatus has degraded performance. Degraded performance can result in unsafe conditions or inefficient performance. Reducing or otherwise adjusting the use of the apparatus can improve safety and/or efficiency.

At decision block 1318, the method 1300 includes determining whether monitoring is active. For example, the method 1300 repeats blocks 1306-1316 for new measurement data yₖ while monitoring is active. Otherwise, the method 1300 ends at block 1320.

Although the threshold state RUc was described above in the context of time to failure, it will be appreciated that in alternative example embodiments the threshold state can correspond to an RU level that is a threshold value away from any event such as transitioning to a state of depletion (e.g., in terms of fuel, energy, ink, feedstock, etc.), a state of completion of a task, a state of substantial loss of performance, a state of resulting in a substantial risk of accident, a state in which the apparatus should be repaired, replaced, or shut off, or the like events/states to be monitored.

Various methods and systems described herein can be applied to a large number of applications. For example, systems can generate estimates that a time to an event has reached some critical level. Examples of such applications include failure prognosis, natural disaster forecasting, and forecasting applied to econometrics. Computational costs can be low and applicability can be high compared to existing high performance TTE estimation solutions. One example reason for this is the aspect that prior knowledge of models related to the evolution of the process that leads to the event can be omitted in some example embodiments. Historical datasets associated to event occurrence and measurements related to the process evolution prior to the event can provide sufficient information for estimation.

### Modules, Components and Logic

Certain example embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as an FPGA or an ASIC) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering example embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In example embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other example embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In example embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

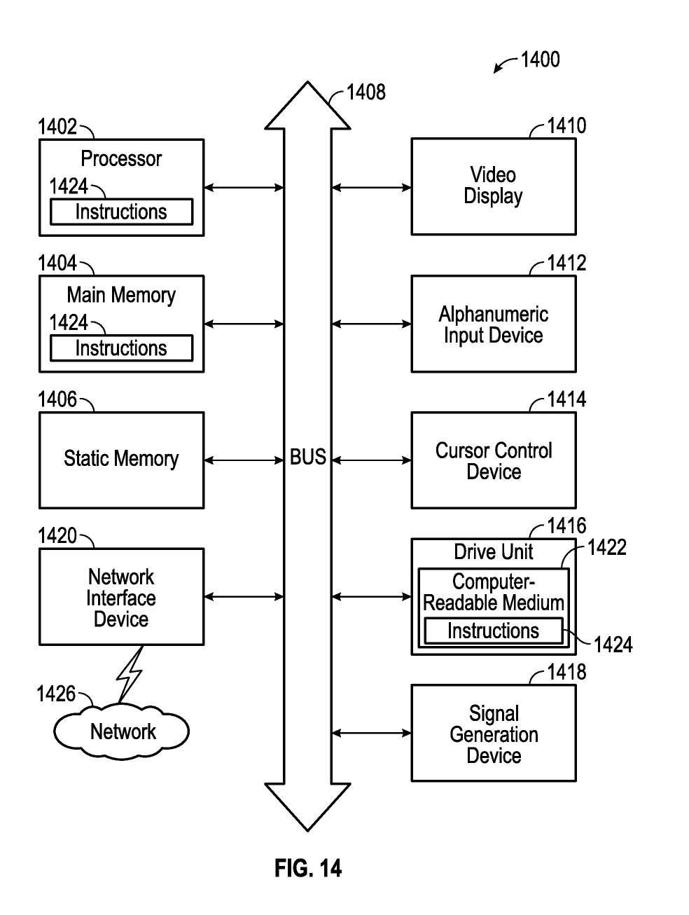

FIG. 14 is a block diagram of a machine in the example form of a computer system 1400 within which instructions 1424 may be executed for causing the machine to perform any one or more of the methodologies discussed herein. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU), or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard or a touch-sensitive display screen), a user interface (UI) navigation (or cursor control) device 1414 (e.g., a mouse), a disk drive unit 1416, a signal generation device 1418 (e.g., a speaker), and a network interface device 1420.

### Machine-Readable Medium

The disk drive unit 1416 includes a computer-readable medium 1422 on which is stored one or more sets of data structures and instructions 1424 (e.g., software) embodying or utilized by any one or more of the methodologies or functions described herein. The instructions 1424 may also reside, completely or at least partially, within the main memory 1404 and/or within the processor 1402 during execution thereof by the computer system 1400, with the main memory 1404 and the processor 1402 also constituting machine-readable media.

While the machine-readable medium 1422 is shown in an example embodiment to be a single medium, the term “machine-readable medium” may include a single medium or multiple media (e.g., a centralized or distributed database, and/or associated caches and servers) that store the one or more instructions 1424 or data structures. The term “machine-readable medium” shall also be taken to include any non-transitory, tangible medium that is capable of storing, encoding, or carrying instructions 1424 for execution by the machine and that cause the machine to perform any one or more of the methodologies of the present inventive subject matter, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and digital optical disks such as compact disks (CDs) and digital video discs (DVDs).

### Transmission Medium

The instructions 1424 may further be transmitted or received over a communications network 1426 using a transmission medium. The instructions 1424 may be transmitted using the network interface device 1420 and any one of a number of well-known transfer protocols (e.g., Hypertext Transfer Protocol (HTTP)). Examples of communication networks include a local area network (LAN), a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions (e.g., instructions 1424) for execution by the machine, and includes digital or analog communications signals or other intangible media to facilitate communication of such software.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A system comprising:
an interface module configured to receive measurement data of an apparatus, at least a portion of the measurement data being indicative of a level of usage of the apparatus;
a data access module configured to access first and second model data of the apparatus, the first model data being indicative of occurrences of an event of usage of the apparatus matched to respective usage levels, the second model data being indicative of measurement quantities matched to respective remaining usage (RU) quantities; and
a filter engine, including one or more processors, configured to:
based on the first model data, generate a first value indicative of a probability that the RU of the apparatus reached a threshold RU value;
based on the second model data, generate a second value indicative of a probability of the received measurement data given that the RU of the apparatus reached the threshold RU value; and
based on the first and second values, generate output data that is indicative of a probability that the RU of the apparatus reached the threshold RU value.

2. The system of claim 1, wherein the received measurement data includes data from a sensor configured to sense a characteristic that is determinative of the level of usage of the apparatus.

3. The system of claim 1, wherein the threshold RU value corresponds to an amount of usage to failure.

4. The system of claim 1, wherein the filter engine is further configured to compare the output data with a predetermined threshold, the filter engine being further configured to schedule maintenance of the apparatus in accordance with a determination that the output data is less than the predetermined first threshold.

5. The system of claim 1, wherein the filter engine is further configured to access data indicative of inventory level of the apparatus, the filter engine being further configured to provide a client device a request message to order a spare part based on the output data and the inventory level.

6. The system of claim 1, wherein the filter engine is further configured to compare the output data with a performance model to determine whether to the apparatus has degraded performance, the filter engine being further configured to adjust a use of the apparatus in accordance with a determination that the apparatus has degraded performance.

7. The system of claim 1, wherein the first model data corresponds to a future lifetime distribution shifted by the threshold RU value, the future lifetime distribution being indicative of failure probabilities of the apparatus.

8. The system of claim 1, wherein the first model data corresponds to a future lifetime distribution shifted by the threshold RU value, the future lifetime distribution being indicative of failure probabilities of the apparatus, the filter engine being configured to determine from the first model data incidents of transitions to the threshold RU value and incidents of non-transitions, the filter engine being configured to generate the first value by comparing the incidents of transitions against the incidents of non-transitions.

9. The system of claim 1, wherein the filter engine is configured to generate the second value based on measurement quantities matched to the respective RU quantities that are less than the threshold RU.

10. The system of claim 1, wherein the first value corresponds to a prior probability calculation, the second value corresponds to likelihood value, and the output data includes to a product of the first and second values.

11. A computer-implemented method of remaining use estimation, the computer-implemented method comprising:
receiving measurement data of an apparatus, wherein at least a portion of the measurement data being indicative of a level of usage of the apparatus;
accessing first and second model data of the apparatus, the first model data being indicative of occurrences of an event of usage of the apparatus matched to respective usage levels, the second model being indicative of measurement quantities matched to respective remaining usage (RU) quantities;
based on the first model data, generating a first value indicative of a probability that the RU of the apparatus reached a threshold RU value given the received measurement data;
based on the second model data, generating a second value indicative of a probability of the received measurement data given that the RU of the apparatus reached the threshold RU value; and
by one or more processors and based on the first and second values, generating output data that is indicative of a probability that the RU of the apparatus reached the threshold RU value.

12. The computer-implemented method of claim 11, wherein the received measurement data includes data from a sensor configured to sense a characteristic that is determinative of the level of usage of the apparatus.

13. The computer-implemented method of claim 11, wherein the threshold RU value corresponds to an amount of RU to failure.

14. The computer-implemented method of claim 11, further comprising:
comparing the output data with a predetermined threshold; and
scheduling maintenance of the apparatus in accordance with a determination that the output data is less than the predetermined first threshold.

15. The computer-implemented method of claim 11, further comprising:
comparing the output data with a performance model to determine whether to the apparatus has degraded performance; and
adjusting a use of the apparatus in accordance with a determination that the apparatus has degraded performance.

16. A machine-readable storage medium embodying instructions that, when executed by a machine, cause the machine to perform operations comprising:
receiving measurement data of an apparatus, at least a portion of the measurement data being indicative of a level of usage of the apparatus;
accessing first and second model data of the apparatus, the first model data being indicative of occurrences of an event of usage of the apparatus matched to respective usage levels, the second model being indicative of measurement quantities matched to respective remaining usage (RU) quantities;
based on the first model data, determining a first value indicative of a probability that the RU of the apparatus reached a threshold RU value;
based on the second model data, determining a second value indicative of a probability of the received measurement data given that the RU of the apparatus reached the threshold RU value; and
based on the first and second values, determining output data that is indicative of a probability that the RU of the apparatus reached the threshold RU value.

17. The machine-readable storage medium of claim 16, wherein the received measurement data includes data from a sensor configured to sense a characteristic that is determinative of the level of usage of the apparatus.

18. The machine-readable storage medium of claim 16, wherein the threshold RU value corresponds to an amount of RU to failure.

19. The machine-readable storage medium of claim 16, further embodying instructions that, when executed by the machine, cause the machine to perform operations comprising:
comparing the output data with a predetermined threshold; and
scheduling maintenance of the apparatus in accordance with a determination that the output data is less than the predetermined first threshold.

20. The machine-readable storage medium of claim 16, further embodying instructions that, when executed by the machine, cause the machine to perform operations comprising:
comparing the output data with a performance model to determine whether to the apparatus has degraded performance; and
adjusting a use of the apparatus in accordance with a determination that the apparatus has degraded performance.
